(19) United States
(12) Patent Application Publication
(10) Pub. No.: US 2016/0320822 A1
(43) Pub. Date: Nov. 3, 2016

(54) POWER SOURCE CONTROLLER AND STORAGE DEVICE

(71) Applicant: FUJITSU LIMITED, Kawasaki-shi (JP)

(72) Inventor: Kuniaki Fujii, Hakui (JP)

(73) Assignee: FUJITSU LIMITED, Kawasaki-shi (JP)

(21) Appl. No.: 15/091,617

(22) Filed: Apr. 6, 2016

(30) Foreign Application Priority Data
Apr. 30, 2015 (JP) 2015-093424

(51) Int. Cl. G06F 1/30; G06F 1/28

(52) U.S. Cl. CPC G06F 1/30; G06F 1/28

(57) ABSTRACT

A power source controller includes: an instruction controller that issues an instruction for power source control to a power source device that supplies an object device with electric power; an abnormality detector that monitors a state of electric power output from the power source device and detects an abnormality of the electric power supplied to the object device; a confirmer that confirms the state of power source control over the power source device; and a power supply stopping controller that stops output of the electric power from the power source device in response to the instruction for power source control from the instruction controller, wherein, when the abnormality is detected and the state of power source control is in a state of instructing power source switching-on is confirmed, the output of the electric power is stopped. With this configuration, electric power can be supplied highly precisely.

### CROSS-REFERENCE TO RELATED APPLICATION

This application is based upon and claims the benefit of priority of the prior Japanese Patent application No. 2015-093424, filed on Apr. 30,2015, the entire contents of which are incorporated herein by reference.

### FIELD

The embodiment discussed herein is directed to a power source controller and a storage device.

### BACKGROUND

FIG. 5 illustrates the configuration of a traditional RAID (Redundant Arrays of Inexpensive Disk) device 100.

The RAID device 100 of FIG. 5 includes a Service Controller (SVC) 300, a Front-End Router (FRT) 400, and multiple Controller Enclosures (CEs) 200.

Each CE 200 includes one or more Controller Modules (CMs), which are however not illustrated. Each CM carries out various controls in the RAID device 100. The FRT 400 is a communication device that achieves communication among the multiple CMs (CM-CM communication). The SVC 300 is a monitoring device that carries out various monitoring in the RAID device 100.

To the RAID device 100 of FIG. 5, external devices 500 are connected. Examples of an external device 500 is a power-source coupled device that controls switching on and off the RAID device 100 in conjunction with a server and an operation panel capable of monitoring the state of operation of the RAID device 100.

The external devices 500 are selected according to the request from the user and are connected to the RAID device 100. For example, the external devices 500 are installed in a rack (not illustrated) of the RAID device 100.

The electric power to operate the external devices 500 is supplied from the SVC 300 included in the RAID device 100 so as to coordinate with the state of the power source of the RAID device 100. This means that the SCV 300 includes a power source device (not illustrated) that supplies the external devices 500 with electric power and a non-illustrated Field Effect transistor (FET) functioning as a switching element interposed between the power source and the external devices 500. The on/off switching by the FET controls the power supply to the external devices 500.

A recent external device 500 tends to incorporate therein a fine-process device to enhance the performance and reduce the power consumption. This requires high accuracy, such as a narrow allowable width of a voltage drop, for electric power that is to be supplied to the external device 500. Supplying highly accurate electric power is achieved through, for example, feedback control by arranging a feedback at the load end of the power source and an adjusting circuit that minimizes the error between the output voltage and the load-end voltage.

[Patent Literature 1] Japanese Laid-open Patent Publication No. 2012-123579

[Patent Literature 2] Japanese Laid-open Patent Publication No. 2002-51449

[Patent Literature 3] Japanese Laid-open Patent Publication No. 2008-305314

However, arranging switching element such as an FET on the power-source supplying line may have a problem of failing in obtaining desired accuracy due to breakdown of the feedback signal by disconnection of the switching element or a voltage drop by a resistor component in the switching device.

### SUMMARY

According to an aspect of the embodiments, a power source controller that controls a power source device, the power source controller includes: an instruction controller that issues an instruction for power source control to the power source device that supplies an object device with electric power; an abnormality detector that monitors a state of electric power output from the power source device and detects an abnormality of the electric power supplied to the object device; a confirmer that confirms the state of power source control over the power source device; and a power supply stopping controller that stops output of the electric power from the power source device in response to the instruction for power source control from the instruction controller, wherein, when the abnormality detector detects the abnormality of the electric power and the confirmer confirms that the state of power source control is in a state of instructing power source switching-on, the power supply stopping controller stops the output of the electric power from the power source device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating the hardware configuration of a storage device according to an example of the first embodiment;

FIG. 2 is a diagram illustrating an example of the hardware configuration to achieve the power-source control function of a storage device of an example of the first embodiment on an external device;

FIG. 3 is a diagram illustrating an example of a functional configuration of a Field Programmable Gate Array (FPGA) of a storage device of an example of the first embodiment;

FIG. 4 is a flow diagram illustrating a succession of procedural steps of controlling supplying electric power to an external device in a storage system according to an example of the first embodiment; and

FIG. 5 is a diagram illustrating the configuration of a traditional RAID device.

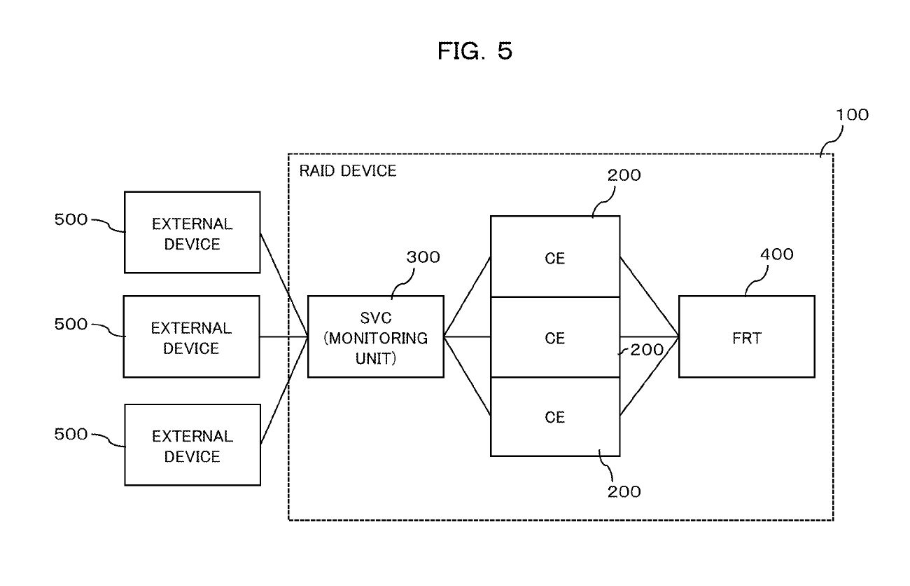

### DESCRIPTION OF EMBODIMENT

Hereinafter, a power-source controller and a storage device according to a first embodiment will now be detailed with reference to accompanying drawings. The following first embodiment is exemplary and has no intention to exclude various modifications and applications of techniques not referred in the first embodiment. In other words, various changes and modifications can be suggested without departing from the spirit of the first embodiment. The drawings do not illustrate therein all the functions and elements included in the embodiment and may include additional functions and elements to those illustrated in the accompanying drawings.

(A) Configuration:

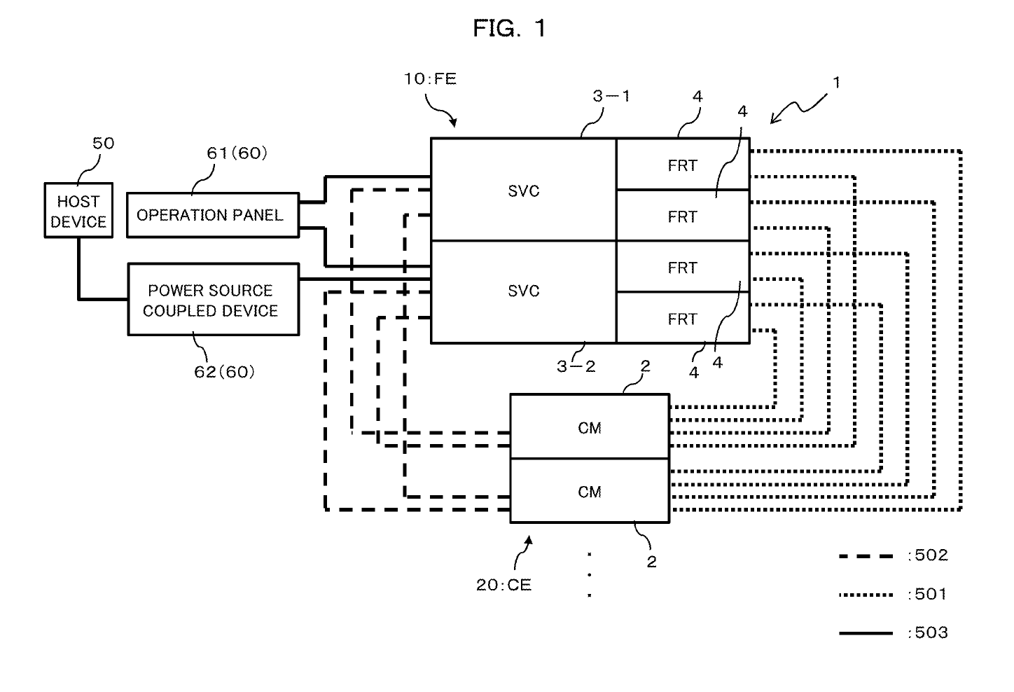

FIG. 1 is a diagram schematically illustrating the hardware configuration of a storage device 1 according to an example of the first embodiment.

The storage device 1 of this embodiment virtualizes memory devices, such as a Hard Disk Drive (HDD), accommodated in a non-illustrated Drive Enclosure (DE) and thereby forms a virtual storage environment. The storage device 1 provides a superordinate host device 50 with the virtual volume.

The storage device 1 of this embodiment is communicably connected to one or more (one in the example of FIG. 1) host devices 50.

The host device 50 is exemplified by an information processing apparatus with a server function, and sends and receives commands of, for example, Network Attached Storage (NAS) and Storage Area Network (SAN) to and from the storage device 1. The host device 50 writes and reads data into and from the volume that the storage device 1 provides by transmitting, for example, an NAS storage access command for reading or writing to the storage device 1.

In response to the input/output request (e.g., a reading command or a writing command) that the host device 50 issues to the volume, the storage device 1 carries out data reading or writing to a memory device corresponding to the volume.

The example of FIG. 1 illustrates a single host device 50, but the number of host devices 50 is not limited to this. Alternatively, two or more host devices 50 may be connected to the storage device 1.

In the example of FIG. 1, the storage device 1 includes a Front End Enclosure (FE) 10 and a CE 20.

The CE 20 includes multiple (two in the example of FIG. 1) CMs 2. Each CM 2 carries out various controls of the storage device 1 and specifically carries out access control to a memory device such as a non-illustrated HDD in response to a storage access request from the host device 50. Here, the two CMs 2 have the same configuration as each other. The above-described DE is connected to the CE 20, and each CM 2 is connected to a memory device installed in the DE.

The FE 10 is a connection device that connects thereto the multiple CMs 2, and includes one or more (two in the example of FIG. 1) SVCs 3-1, 3-2 and one or more (four in the example of FIG. 1) FRTs 4. In the example of FIG. 1, the FE 10 accommodates the SVCs 3-1, 3-2 and multiple FRTs 4 in the same casing.

Each FRT 4 is a communication device that achieves communication among the multiple CMs 2 (CM-CM communication). The multiple FRTs 4 have the same configuration as one another. Each FRT 4 is connected to all the CMs 2 via Peripheral Component Interconnect Express (PCIe) buses 501. In other words, each CM 2 is connected to all the FRTs 4 via the PCIe buses 501.

Furthermore, each FRT 4 is connected to the SVCs 3-1, 3-2 via a non-illustrated midplane. In the example of FIG. 1, two FRTs 4 are connected to each of the SVCs 3-1, 3-2.

The SVCs 3-1, 3-2 are each a monitoring device that monitors various factors in the storage device 1. For example, the SVCs 3-1, 3-2 collect error state information through the communication with each CM 2 and accumulates an error log.

Hereinafter, when one of the SVCs is discriminated from the remaining, a reference number 3-1 or 3-2 is used, but when an arbitrary SVC is represented by the reference number 3.

Each SVC 3 also functions as a managing device that manages the communication between a CM 2 and an FRT 4. Each SVC 3 is connected to all the CMs 2 via monitoring communication buses 502.

In addition, to the SVCs 3-1, 3-2, one or more electronic devices that function under a state of being connected to the storage device 1 are connected via external device connecting buses 503.

In the example of FIG. 1, an operation panel 61 is connected both to the SVCs 3-1, 3-2 and a power source coupled device 62 is further connected to the SVC 3-2.

The operation panel 61 functions as an input device with which the operator inputs various data and also functions as a display device that displays thereon various pieces of information that is to be provided to the operator. An example of the operation panel 61 maybe a combination of a keyboard and a Liquid Crystal Display (LCD) or may be a touch panel that integrates the both functions. The operation panel 61 may be variously modified.

The power source coupled device 62 is a control device that activates the host device 50 and the storage device 1 in conjunction with each other and specifically starts each element included in the storage device 1 in synchronization with switching-on the host device 50.

The operation panel 61 and the power source coupled device 62 are connected to the SVCs 3 and the host device 50 via the external device connecting buses 503. The operation panel 61 and the power source coupled device 62 are used as external devices that function when being connected to the storage device 1 of the first embodiment.

Hereinafter, the operation panel 61 and the power source coupled device 62 may be sometimes referred to as external devices 60. The external devices connected to the storage device 1 of the first embodiment are not limited to the operation panel 61 and the power source coupled device 62, and may be variously modified.

The power supply to the external device 60 is controlled by the SVCs 3. This means that the SVCs 3 have a power-source control function that controls power supply to the external devices 60.

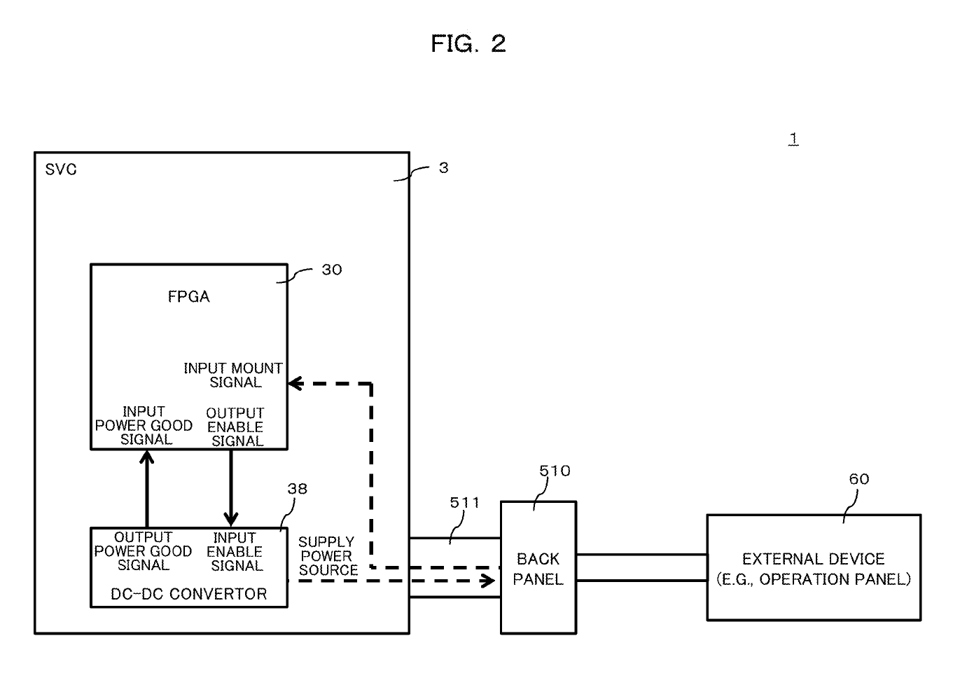

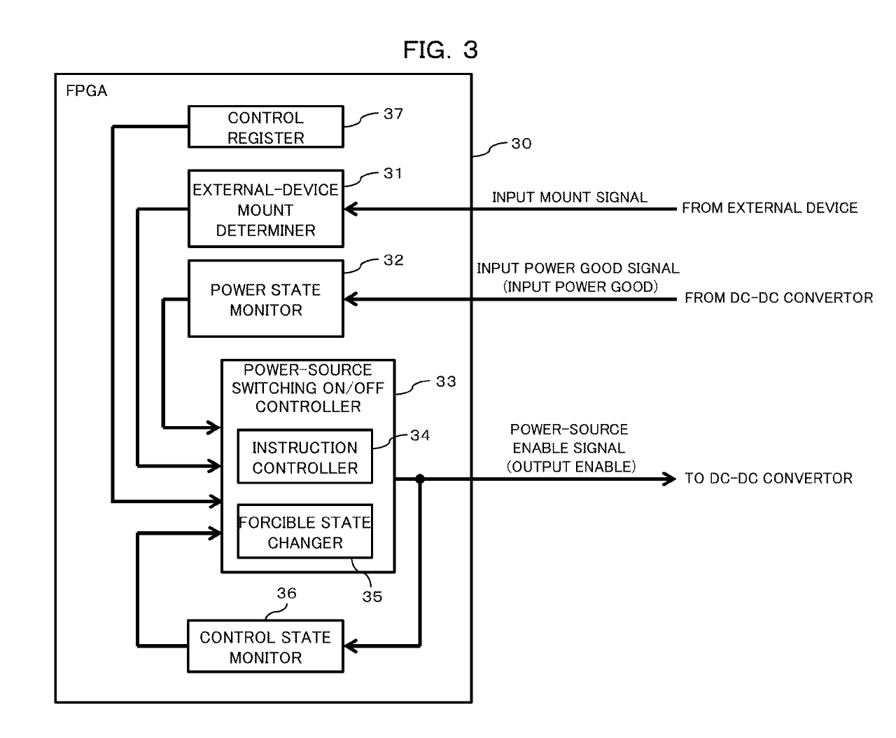

FIG. 2 is a diagram illustrating an example of the hardware configuration to achieve the power-source control function that the storage device 1 of an example of the first embodiment has and that is directed to the external devices 60; and FIG. 3 is a diagram illustrating the functional configuration of the FPGA 30 in the storage device 1 of an example of the first embodiment.

As illustrated in FIG. 2, each SVC 3 includes an FPGA 30 and a DC-DC convertor 38, which collectively achieve the power-source control function directed to an external device 60.

To the SVC 3, a back panel 510 is connected via a connector 511. To the back panel 510, one or more external devices 60 are detachably connected via the external device connecting buses 503.

The DC-DC convertor 38 is an electric power converting circuit device that converts direct-current electric power supplied from a non-illustrated electric power supplying device to direct-current electric power that is to be supplied to the external devices 60. An instruction for switching on the power source, in the form of a power-source enable signal, is input from the FPGA 30 to the DC-DC convertor 38. Specifically, the power-source enable signal is input into an enable input terminal disposed on the DC-DC convertor 38.

For example, when a power-source enable signal input in the DC-DC convertor 38 is High (H), an instruction for power supply to the external device 60 is validated while when the power-source enable signal is Low (L), the instruction for power supply to the external device 60 is invalidated and power supply to the external devices 60 is instructed to be stopped.

Namely, when receiving an input of a power-source enable signal (H) from the FPGA 30, the DC-DC convertor 38 supplies electric power to the external devices 60. The electric power is supplied from the DC-DC convertor 38 through the connector 511, the back panel 510, and the external device connecting buses 503 to the external devices 60. In contrast, when receiving an input of a power-source enable signal (L) from the FPGA 30, the DC-DC convertor 38 stops the electric power supply to the external devices 60.

The DC-DC convertor 38 outputs a power good signal, representing a state of power supply to the external devices 60, to the FPGA 30. The DC-DC convertor 38 outputs, when being in the state of normally supplying electric power to the external devices 60, High (H) as power good. In contrast, the DC-DC convertor 38 outputs, when being in a state of not supplying electric power to the external devices 60 for somewhat abnormality, Low (L) as power good.

The power good signal is output from a power good output terminal disposed in the DC-DC convertor 38 and then input into a power good input terminal disposed in the FPGA 30.

The FPGA 30 is an integrated circuit having a rewritable circuit configuration, and as illustrated in FIG. 3, functions as various functional elements that achieve the power-source control function to control power supply to each external device 60. Specifically, as illustrated in FIG. 3, the FPGA 30 has the functions of an external-device mount determiner 31, a power state monitor 32, a power-source switching on/off controller 33, a control state monitor 36, and a control register 37.

The control register 37 prepares therein a data storing region for each external device 60. In the data storing region, register value (power-source supplying flag) for the corresponding 60 is stored. The power-source switching on/off controller 33 that is to be detailed below supplies electric power to the external device 60 for which a predetermined register value (for example, “1”) is set in the control register 37. This means that the control register 37 functions as a memory that stores therein control information (register value) indicating whether the external device 60 is an object of power supply.

A power-source supplying flag is set into the control register 37 by, for example, a non-illustrated processor executing the firmware.

The external-device mount determiner 31 determines whether an external device 60 is connected to the storage device 1 of the first embodiment. For example, when an external device 60 is connected to the back panel 510 via the external device connecting bus 503, a mount signal (H) is input into the FPGA 30. When the mount signal (H) is input, the external-device mount determiner 31 determines that the external device 60 is connected. This means that the external-device mount determiner 31 functions as a connection confirmer that confirms connection of the external device 60.

The external-device mount determiner 31 has a function of detecting a change in the connection state of an external device 60 through monitoring the mount signal. This change in the connection state is detected by, for example, detecting an edge of the mount signal.

The power state monitor 32 monitors the state of the electric power output from the DC-DC convertor 38 by referring to a power good signal input thereto from the DC-DC convertor 38. Detecting a change in the power good signal from an asserting state (High) to a negating state (Low), the power state monitor 32 detects the presence of abnormality in the electric power being supplied to the external device 60.

Namely, the power state monitor 32 functions as an abnormality detector that monitors the state of electric power output from the DC-DC convertor 38 and detects an abnormality of the electric power supplied to the external device 60.

The power-source switching on/off controller 33 controls power supply from the DC-DC convertor 38 to each external device 60. The power-source switching on/off controller 33 includes an instruction controller 34 and a forcible state changer 35.

The instruction controller 34 instructs the DC-DC convertor 38 to switch on the external device 60 (i.e., instruction for switching on the power source) by outputting a power-source control signal to the DC-DC convertor 38. Specifically, the instruction controller 34 turns the power-source enable signal which is directed to the DC-DC convertor 38 and which concerns an external device 60 for which the flag “1” is set in the control register 37 into an asserting state (H) to validate the instruction for power-source supplying. In contrast, the instruction controller 34 turns the power-source enable signal which is directed to the DC-DC convertor 38 and which concerns an external device 60 for which the flag “1” is not set in the control register 37 into a negating state (L) to invalidate the instruction for power-source supplying, so that the power source to the external device 60 is in a state of instructing power source switching-off.

The forcible state changer 35 changes the power-source enable signal output from the power-source switching on/off controller 33 from the asserting state (H) to the negating state (L) to forcibly invalidate the instruction for power-source supplying. In other words, the forcible state changer 35 invalidates the power-source enable signal and thereby changes the state of instructing power source switching-on into the state of instructing power source switching-off.

Under a state where the power-source enable signal from the power-source switching on/off controller 33 is forcibly invalidated, the power-source enable signal is kept to be in the negate state even when the firmware sets the power-source supplying flag to be “1” in the control register 37.

When the power state monitor 32 detects the negating state (i.e., abnormality in the electric power) of the power good signal and concurrently the control state monitor 36 that is to be detailed below determines that the power-source enable signal issued to the DC-DC convertor 38 is an asserting state, the forcible state changer 35 forcibly changes the states of the power-source enable signal output from the power-source switching on/off controller 33 into the negate state.

When the power-source enable signal output from the instruction controller 34 to the DC-DC convertor 38 is in the asserting state and the electric power supplied to an external device 60 has abnormality under a state of the external device 60 is being connected, it seems that the power source has abnormality and the external device 60 needs to be protected.

Under the above state, the forcible state changer 35 forcibly changes the power-source enable signal output from the power-source switching on/off controller 33 into the negating state.

The control state monitor 36 confirms a state (state of power-source control) of the power-source enable signal that the power-source switching on/off controller 33 (instruction controller 34) issues to the DC-DC convertor 38. Namely, the control state monitor 36 confirms whether the power-source enable signal that the power-source switching on/off controller 33 (instruction controller 34) issues to the DC-DC convertor 38 is in the asserting state. Then the control state monitor 36 inputs the result of the confirmation into the forcible state changer 35.

(B) Operation:

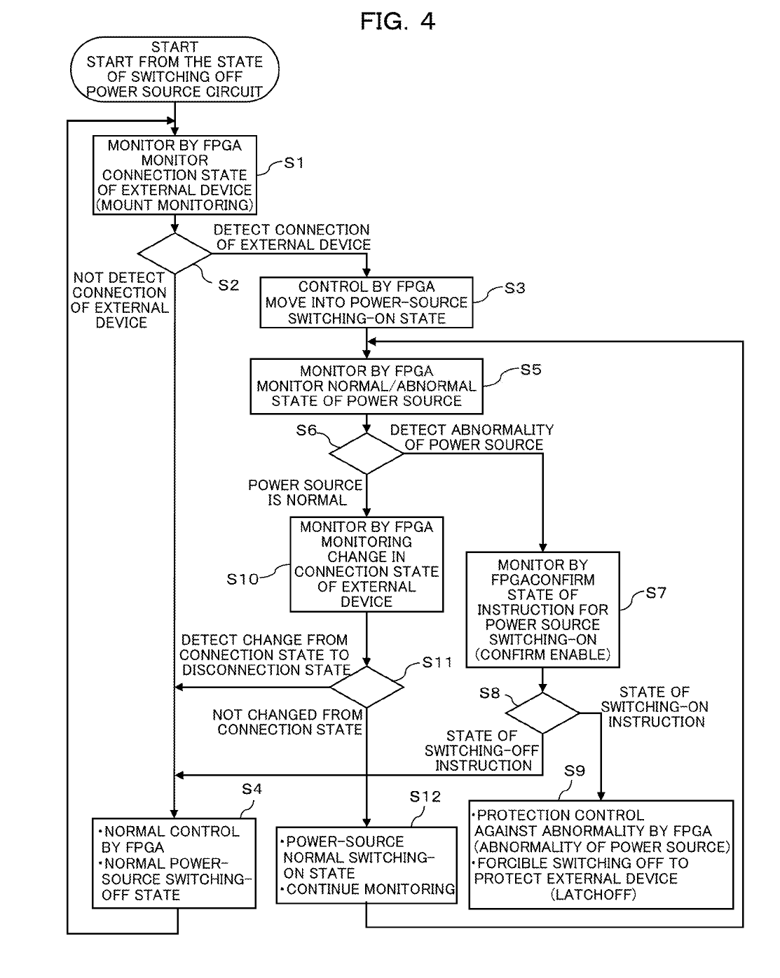

Description will now be made in relation to a method for controlling electric-power supply to an external device 60 in the storage device 1 of the first embodiment configured as the above with reference to the flow diagram (step S1-S12) of FIG. 4.

In the initial state, the DC-DC convertor 38 does not supply the electric power. This means that the procedure of the first embodiment starts from the state of switching off the power source circuit.

In step S1, the external-device mount determiner 31 monitors an input of a mount signal (H) and thereby monitors the state of connection of each external device 60 (mount monitoring).

When the monitoring a connection state of an external device 60 (step S2) results in not detecting input of the mount signal (H), that is, when the connection of the external device 60 is not detected (see the route of “not detect connection of external device” of step S2), the process moves to step S4.

In step S4, the FPGA 30 carries out normal control and the instruction controller 34 outputs a power-source enable signal (L) to maintain the state (power-source switching-off state) of stopping electric-power supply from the DC-DC convertor 38. Then the process returns to step S1.

When the monitoring a connection state of an external device 60 in step S2 results in detecting input of the mount signal (H), that is, when the connection of the external device 60 is detected (see the route of “detect connection of external device” of step S2), the process moves to step S3. In the following steps S3-S12, the FPGA 30 determines whether the power source has abnormality.

In step S3, the instruction controller 34 sets the power-source enable signal to the asserting state (H) to cause the DC-DC convertor 38 to supply electric power to the external device 60. This means that the process moves into a power-source switching-on state from the DC-DC convertor 38.

In the storage device 1 of the first embodiment, at the time when the DC-DC convertor 38 starts supplying electric power to the external device 60, the external device 60 is already mounted (see steps S1 and S2). Therefore, rush current does not flow into the external device 60.

In step S5, the power state monitor 32 monitors the state of the electric power output from the DC-DC convertor 38 by referring to a power good signal input from the DC-DC convertor 38. In other words, the power state monitor 32 monitors the normal/abnormal state of electric-power supply from the DC-DC convertor 38.

When the monitoring by the power state monitor 32 (step S6) results in detecting the negating state of the power good signal (see the route of “detect abnormality of power source” in step S6), the process moves to step S7.

In step S7, the control state monitor 36 confirms whether the power source enable signal that the power-source switching on/off controller 33 (instruction controller 34) issues to the DC-DC convertor 38 is in the asserting state.

The result of the monitoring by the control state monitor 36 (step S8) confirms that the power source enable signal issued to the DC-DC convertor 38 is in the asserting state, that is, when the instruction for switching on the power source from the power-source switching on/off controller 33 is in the valid state (see the route of “state of switching-on instruction” in step S8), the process moves to step S9.

In step S9, the power source has abnormality and therefore the external device 60 needs to be protected. In order to protect the external device 60, the forcible state changer 35 forcibly makes the power source enable signal output from the power-source switching on/off controller 33 into the negate state and is consequently invalidated. Accordingly, the electric power that the DC-DC convertor 38 supplies to the external device 60 is forcibly disconnected.

The state of being invalidated by the forcible state changer 35 is cancelled, for example, after the person in charge of maintenance replaces the DC-DC convertor 38 with another DC-DC convertor. Namely, the replacement of the DC-DC convertor 38 would not detect the power-source abnormality any longer, the power source enable signal directed to an external device 60 for which the flag “1” is set in the control register 37 is regained from the forcible negating state to the asserting state, so that the instruction for power-source supplying is validated.

When the FPGA 30 is reset due to, for example, interruption to electric-power supply to the FPGA 30, the forcible state changer 35 is also initialized to carry out the process of the flow diagram of FIG. 4 from “START” on the top again.

When the forcible state changer 35 is initialized by resetting the FPGA 30 without normally cancelling the abnormality in the power source, the abnormality in the power source is detected again after the booting of the FPGA 30 is completed, and the storage device 1 goes into a state where the power source enable signal is forcibly invalidated.

When the result of the monitoring by the control state monitor 36 (step S8) confirms that the power source enable signal issued to the DC-DC convertor 38 is in the negating state, that is, when the instruction for switching off the power source is issued from the power-source switching on/off controller 33 (see the route of “state of switching-off instruction” in step S8), the process moves to step S4.

In addition, when the monitoring by the power state monitor 32 (step S6) results in detecting the asserting state of the power good signal (see the route of “power source is normal” in step S6), the process moves to step S10.

In step S10, the external-device mount determiner 31 monitors a change in the connection state of the external device 60. When the monitoring (step S11) results in detecting a change from the connection state to the disconnection state of the external device 60 (see the route of “detect change from connection state to disconnection state” in step S11), the process moves to step S4.

If no change is detected in the connection state of the external device 60 (see the route of “not changed from connection state” in step S11), the process moves to step S12.

In step S12, a state where the DC-DC convertor 38 normally supplies power source to the external device 60 is maintained. After that, the process moves to step S5 and FPGA 30 continuously monitors the DC-DC convertor 38.

(C) Effects:

As described above, when the power state monitor 32 detects a power good signal in the negating state (power source abnormality) and concurrently when the control state monitor 36 determines that the power source enable signal being issued to the DC-DC convertor 38 is in the asserting state in the storage device 1 of the first embodiment, the forcible state changer 35 forcibly changes the power source enable signal output from the power-source switching on/off controller 33 into the negating state.

This configuration forcibly stops the DC-DC convertor 38 from supplying electric power to the external device 60 under a state of determining that power-source abnormality is occurring. Consequently, it is possible to protect the external device 60 even from the abnormality in the DC-DC convertor 38.

The storage device 1 of the first embodiment can switch on and off the electric-power supply to the external device 60 without an FET arranged on the power supply line to the external device 60, so that power supply can be precisely accomplished. In addition, the electric power supply from the DC-DC convertor 38 is started after the external device 60 is mounted. Thereby, no rush current flows into the external device 60. Consequently, the external device 60 can be protected from rush current.

(D) Others:

The above technique is not limited to the foregoing embodiment and various changes and modification can be suggested without departing from the spirit of the first embodiment. The configurations and the procedural steps of the first embodiment can be selected, omitted, and combined.

For example, the number of SVCs 3, the number of CMs 2, and the number of FRTs 4 included in the storage device 1 are not limited to those of the first embodiment, and may be variously modified.

The external devices 60 are not limited to the operation panel 61 and the power source coupled device 62, and any electronic device can be applied.

In the foregoing embodiment, the FPGA 30 exerts the functions as the external-device mount determiner 31, the power state monitor 32, the power-source switching on/off controller 33 (the instruction controller 34 and the forcible state changer 35), and the control state monitor 36, but is not limited to this. Alternatively, at least part of the above functions may be achieved by a processor executing a program (firmware).

The program (firmware) that achieves the external-device mount determiner 31, the power state monitor 32, the power-source switching on/off controller 33 (the instruction controller 34 and the forcible state changer 35), and the control state monitor 36 are provided in the form of being recorded in a tangible and non-transient computer-readable storage medium, such as a flexible disk, a CD (e.g., CD-ROM, CD-R, and CD-RW), a DVD (DVD-ROM, DVD-RAM, DVD-R, DVD+R, DVD-RW, DVD+RW, and HD DVD), a Blue-ray disk, a magnetic disk, an optical disk, and an magneto-optical disk. A computer reads the program from the recording medium using the medium reader and stores the read program in an internal or external storage device for future use. Alternatively, the program may be recorded in a recording device (recording medium) such as a magnetic disk, an optical disk, or a magneto-optical disk, and may be provided from the recording device to the computer via a communication path.

Further alternatively, in achieving the functions of the external-device mount determiner 31, the power state monitor 32, the power-source switching on/off controller 33 (the instruction controller 34 and the forcible state changer 35), and the control state monitor 36, the program stored in an internal storage device (e.g., Random Access Memory (RAM) and Read Only Memory (ROM)) is executed by the microprocessor (e.g., Central Processing Unit (CPU) or Micro Processing Unit (MPU)) of the computer. At that time, the computer may read the program stored in the recording medium and may execute the program.

Those ordinarily skilled in the art can carry out and manufacture the above embodiment by referring to the above disclosure.

The above first embodiment can precisely supply electric power.

All examples and conditional language recited herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A power source controller that controls a power source device, the power source controller comprising:
an instruction controller that issues an instruction for power source control to the power source device that supplies an object device with electric power;
an abnormality detector that monitors a state of electric power output from the power source device and detects an abnormality of the electric power supplied to the object device;
a confirmer that confirms the state of power source control over the power source device; and
a power supply stopping controller that stops output of the electric power from the power source device in response to the instruction for power source control from the instruction controller, wherein
when the abnormality detector detects the abnormality of the electric power and the confirmer confirms that the state of power source control is in a state of instructing power source switching-on, the power supply stopping controller stops the output of the electric power from the power source device.

2. The power source controller according to claim 1, further comprising a memory that stores therein control information representing whether the object device is a device that is to be supplied with the electric power, wherein
the instruction controller issues, to the power source device, the instruction for power source control over the object device in accordance with the control information.

3. The power source controller according to claim 2, wherein the power supply stopping controller comprises a forcibly state changer that forcibly changes, when the control information indicates that the object device is a device that is to be supplied with the electric power, the abnormality detector detects the abnormality of the electric power, and the confirmer confirms that the state of power source control is in a state of instructing power source switching-on, the state of instructing power source switching-on into a state of instructing power source switching-off regardless of the instruction for power source control by the instruction controller.

4. The power source controller according to claim 1, further comprising a connection confirmer that confirms connection of the object device, wherein when the connection confirmer detects a change in a state of the connection of the object device, the instruction controller issues an instruction for switching off the power source as the instruction for power source control.

5. The power source controller according to claim 4, wherein:
under a state where the output of the electric power from the power source to the object device is stopped in accordance with the instruction of switching off the power source, the connection confirmer confirms whether the object device is connected; and
when the connection confirmer confirms that the object device is connected, the instruction controller issues an instruction for switching on the power source as the instruction for power source control.

6. A storage device comprising:
a memory device;
a power source device that supplies an object device with electric power;
an instruction controller that issues an instruction for power source control to the power source device;
an abnormality detector that monitors a state of electric power output from the power source device and detects an abnormality of the electric power supplied to the object device;
a confirmer that confirms the state of power source control over the power source device; and
a power supply stopping controller that stops output of the electric power from the power source device in response to the instruction for power source control from the instruction controller, wherein
when the abnormality detector detects the abnormality of the electric power and the confirmer confirms that the state of power source control is in a state of instructing power source switching-on, the power supply stopping controller stops the output of the electric power from the power source device.

7. The storage device according to claim 6, further comprising a memory that stores therein control information representing whether the object device is a device that is to be supplied with the electric power, wherein
the instruction controller issues, to the power source device, the instruction for power source control over the object device in accordance with the control information.

8. The storage device according to claim 7, wherein the power supply stopping controller comprises a forcibly state changer that forcibly changes, when the control information indicates that the object device is a device that is to be supplied with the electric power, the abnormality detector detects the abnormality of the electric power, and the confirmer confirms that the state of power source control is in a state of instructing power source switching-on, the state of instructing power source switching-on into a state of instructing power source switching-off regardless of the instruction for power source control by the instruction controller.

9. The storage device according to claim 6, further comprising a connection confirmer that confirms connection of the object device, wherein when the connection confirmer detects a change in a state of the connection of the object device, the instruction controller issues an instruction for switching off the power source as the instruction for power source control.

10. The storage device according to claim 9, wherein:
under a state where the output of the electric power from the power source to the object device is stopped in accordance with the instruction of switching off the power source, the connection confirmer confirms whether the object device is connected; and
when the connection confirmer confirms that the object device is connected, the instruction controller issues an instruction for switching on the power source as the instruction for power source control.
